(19) United States
(12) Patent Application Publication
(10) Pub. No.: US 2025/0235033 A1
(43) Pub. Date: Jul. 24, 2025

(54) IMPROVED METHOD AND APPARATUS FOR BREWING AND EXTRACTING COFFEE

(71) Applicant: Ajeyudu Pathuri, Telangana (IN)

(72) Inventor: Ajeyudu Pathuri, Telangana (IN)

(21) Appl. No.: 18/854,064

(22) PCT Filed: May 1, 2023
(86) PCT No.: PCT/IN2023/050420

§ 371 Date: Oct. 4, 2024

(30) Foreign Application Priority Data
Jul. 3, 2022 (IN) 202241038245

(51) Int. Cl. A47J 31/36; A47J 31/46; A47J 31/52

(52) U.S. Cl. CPC A47J 31/3671; A47J 31/461; A47J 31/52

(57) ABSTRACT

The present invention relates to an improved method and apparatus for brewing and extracting coffee in a coffee machine. The preferred embodiments of the present invention disclose a method and apparatus for even and efficient extraction of coffee solubles from coffee grounds in the brewing chamber, by inserting water into the coffee grounds at two or more locations. These two locations may, as described in the preferred embodiments of the present invention, be on opposite sides of the coffee grounds.

### TECHNICAL FIELD

The present invention is directed, in general, towards the extraction of coffee in coffee machines. The present invention particularly relates to an improved method and apparatus for brewing and extracting coffee, especially when making espresso.

### BACKGROUND ART

Coffee is an extremely popular drink that is consumed worldwide in different forms. Billions of cups of coffee are enjoyed every year by consumers around the world. Coffee consumption is common among people of all ages and at all times of the day. It is taken at home, at work, in cafes, in bars and in restaurants. It is becoming increasingly common to see coffee beverages being prepared by fully automated machines, where consumers can get a coffee beverage of their choice, by just pressing a button. The entire process of preparing the coffee beverage is automated within the machine itself, from the grinding of the coffee beans to the dispensing of the beverage.

Coffee generally refers to the liquid comprising of various substances found in the coffee bean such as fruit acids, caffeine, lipids, melanoidins, carbohydrates and plant fibre dissolved in water. However, coffee can also refer to different forms of coffee, in different physical states, such as coffee beans, coffee powder, coffee grounds etc.

Coffee, the drink, is sourced from coffee beans. Coffee beans are grinded to form coffee grounds. Coffee grounds are brewed in order to prepare coffee for consumption as a drink. Brewing is a method of preparing coffee, generally from roasted coffee grounds, by passing water or steam through the coffee grounds. However, other materials and steps may also be involved in the process of brewing coffee.

Although coffee beans are generally ground to form coffee grounds before brewing, coffee beans may be brewed directly without grinding.

The water used to brew the coffee or extract the coffee solubles may be of any temperature and includes water existing in one or more physical states. Coffee solubles refer to substances in coffee beans or coffee grounds that can be dissolved by water. For example, even though hot water (with steam) is used to brew coffee, there are also methods of extracting coffee using cold water such as in cold pressed espressos.

Coffee beans, coffee powder and coffee grounds are different forms of coffee in the solid state. Coffee beaus refer to the seeds of the Coffea plant, which is the original source of coffee. Coffee powder and coffee grounds refer to the finely ground version of coffee beans which is used to prepare coffee beverages.

When preparing coffee beverages, the coffee solubles need to be extracted from the coffee grounds into the water which is used to brew the coffee. This process of extraction of coffee solubles into water is generally referred to as coffee extraction.

Coffee extraction generally refers to the process of dissolving compounds such as caffeine, carbohydrates, lipids and oils from the coffee grounds into water. Coffee extraction is a precise process, and there are certain parameters that determine the taste, aroma, and strength of the brewed coffee.

Coffee comprises of several substances, including the ones listed above. Each of these substances extracts into the brew liquid at different times and imparts different flavours to the resulting extract. Approximately 25-35% of a coffee bean is water soluble, and only about 20% of these soluble substances are desirable in a brew from a taste perspective. The other substances can add a bitter or papery off-flavour to the coffee liquid. The extraction of these substances can be improved by increasing the solubility. Solubility can be increased by varying temperature, pressure and agitation. Extraction of the coffee can be tweaked by changing parameters such as the grind size and the extraction time.

Coffee preparation is the process of turning coffee beans into a beverage. While the particular steps of preparing coffee vary with the type of coffee and the raw materials, the process of preparing coffee includes four basic steps: raw coffee beans are roasted, the roasted coffee beans are then grounded, the ground coffee is then mixed with water (depending on the method of brewing} for a specific time (brewed), and finally, the liquid coffee is separated from the used grounds. The granularity and size of the coffee grounds has an impact on the taste of the drink that is prepared using the said coffee grounds.

Espresso is the most commonly brewed extracted coffee, especially when using coffee/espresso machines. Espresso is prepared when water is passed through finely ground coffee grounds/beans under high pressure. Other commonly consumed beverages, such as cappuccinos and lattes, are prepared from the espresso which is extracted from the coffee grounds.

Coffee can be brewed in several different ways, but these methods fall into four main groups depending on how the water is introduced to the coffee grounds. These main groups are decoction (through boiling), infusion (through steeping), gravitational feed (used with percolators and in drip brewing), and pressurised percolation (as with espresso).

The human palate and taste sensory system generally prefers a Total Dissolved Solubles (TDS) percentage from 18% to 22% in coffee. Coffee with TDS lower than 18% tastes undesirably acidic with low sweetness, low body, low bitterness and weak aftertaste. Coffee with TDS lower than 18% is called under-extracted coffee. Coffee with TDS higher than 22%, i.e. over-extracted coffee, has unpleasant flavours with high bitterness. However, there are limitations to the extent io which the taste profile (acidity, sweetness, bitterness etc.) in fully automated coffee machines can be calibrated, as not all variables and parameters can be controlled in such a coffee machine.

Espresso is produced when water is passed through the coffee grounds at high pressure. There are precisely defined parameters for an ideal espresso. Espresso forms the base for almost all coffee recipes and beverages. All of these must be in balance with each other to extract the best out of the coffee grounds. Conventional methods for making espresso include the following steps: grinding the coffee beans, tamping the ground coffee to form a flat and compressed coffee bed, brewing and extracting the coffee solubles from the coffee bed, including an option of pre-infusion of the coffee bed. All of these steps are automated in a fully automated coffee machine.

The tamping step plays an important role in the coffee extraction process. The conventional tamping method in a coffee machine is to fill the coffee grounds into a container, generally present in the brewing chamber, that generally contains one or more filters. Brewing chamber refers to the container in the coffee machine where the coffee brewing and extraction processes take place. The brewing chamber is where the coffee bed and the water first come into contact with each other.

The ground coffee, then heaped in the brewing chamber, is levelled to form a flat and uniform surface. A tamping device is then used, sometimes with the help of a piston (upper and/or lower), to press the coffee downwards and compact it. This compact coffee in the filter is generally referred to as the coffee bed, which is present in the brewing chamber. Tamping the coffee grounds helps in achieving evenly extracted coffee.

The water is inserted into and passed under pressure through the coffee grounds. This is followed by extraction of the espresso, thus creating an aromatic crema and strong taste. Tamping the coffee grounds increases the resistance against the pressurised water, which increases the extraction time of the coffee solubles. Hence, the dissolution of the coffee solubles in the water is improved.

Existing coffee brewers and brewing/extraction machines do not extract coffee solubles in an even and efficient manner since they have water inserted into the coffee grounds at one location and the water flows through the coffee bed in a single direction, generally with a pre-infusion option. Existing coffee brewers, in such implementations, are unable to evenly extract the coffee solubles from the coffee bed, also due to water's saturation limit with coffee. Hence, there are between 5% to 20% of the coffee solubles in the coffee bed that are not extracted, due to the said water saturation limit through the different extraction stages.

Uni-directional brewers could refer to gravity or anti-gravity (vertical) brewers, in which water flows through the coffee bed or coffee puck from top to bottom (gravity) or from bottom to top (anti-gravity).

Due to water's saturation limit, water extracts more coffee solubles on one side than the other side, as it flows through the coffee bed. Thus, there will be higher extraction of coffee solubles on the side of the coffee bed through which the water enters the coffee bed, when compared to the extraction of coffee solubles at the other side of the coffee bed from where the water exits with coffee solubles towards the cup dispenser. This means that in a vertical gravity brewer, coffee extraction at the top of the coffee bed is higher than the extraction at the bottom of the coffee bed as the water flows top to bottom.

In the same way, in an anti-gravity vertical brewer, water extracts more coffee solubles at the bottom side when compared to the extraction that occurs at the top side of the coffee bed. This is because the water flows, under pressure, from the bottom of the coffee bed to the top of the coffee bed. Idins, in the existing brewing and extraction technology, if extraction continues for longer than 20 seconds, the extracted coffee begins io taste increasingly unpleasant with time.

Patent No. CA2608312C discloses a “Coffee making apparatus” in which ground coffee is infused with hot water under pressure. With the help of extension of piston head, hot water is allowed to enter a brewing chamber to produce coffee and the retraction of piston head allows the infusion chamber assembly to be removed for cleaning. So here, brewing of coffee is taking place in one direction only. Thus, due to uneven extraction of ground coffee, the taste of the brewed coffee may result in unpleasant flavours.

KR101970614B1 discloses an “Apparatus and method for brewed and espresso drink generation.” It discloses several embodiments for the espresso-making device and process comprising two chambers-upper and bottom, sintered filters, an espresso puck, valves for water and air flow, transducers, tamper, and actuator. It also prepares an espresso by one directional flow of water which may result in an unpleasant flavour of espresso due to the uneven extraction of coffee in the coffee puck.

WO2008100597A1 discloses “Espresso maker and method” in which hot water is allowed to contact a coffee filter pod in a chamber and a minimum pressure is maintained inside the chamber for the releasing of valve so that liquid (espresso) flows through the filter pod into a container. It also uses one directional flow of water for the preparation of espresso.

CN108175279B discloses “Coffee brewing method” in which portions of coffee grounds are extracted at different pressures. It specifically focuses on the pressure differences in the different stages of the extraction process so that the bitter taste of the coffee caused by excessive extraction is avoided, but it also works on the unidirectional flow of water.

The existing technologies used to brew and extract coffee/espresso in coffee machines do not evenly and efficiently extract the coffee solubles into the extracted coffee. They primarily work with water flowing through the coffee bed in one direction which, due to the limitations provided above (including the saturation limit of water), often leads to uneven and inefficient extraction of coffee with an undesirable taste profile. This process also leaves a significant part of the coffee unextracted as the water reaches its saturation limit as it flows through the coffee bed.

Furthermore, it is difficult to reliably and accurately modulate and calibrate the taste profile of the coffee in automated coffee machines, due to hardware and software limitations in controlling variables such as the granularity of the coffee, water pressure, water temperature etc. Changing the granularity of coffee or the grind size of the coffee grounds is a task that requires a high level of skill and expertise. This is generally done by skilled professionals, on-site, where the coffee machine is located, for which regular coffee on-site visits are required. It requires several trial-and-error attempts in order to arrive at the desirable grind size of the coffee grounds for extracting espresso with the desired taste profile. Therefore, the existing method of calibrating and modifying the grind size of the coffee grounds is expensive, complex, and leads to unnecessary wastage of natural and human resources.

Considering the limitations described above, it is extremely hard to evenly brew coffee and extract a balanced espresso with the desirable and palatable roast profiles or doses by using the existing coffee brewing and extraction technology. It is also difficult to obtain an improvement in the body and sweetness of the extracted coffee, using the existing technology, without increasing the dose of the coffee beans/grounds. It is tremendously hard to improve the juiciness and desired acidity of the extracted coffee without reducing the volume of the coffee.

Accordingly, what is needed is an improved method and apparatus for brewing and extracting coffee which can evenly and efficiently extract coffee solubles present within the coffee bed, to improve the taste profile of the extracted coffee. Such brewing and extraction technology for coffee would reduce wastage and improve the solubility of coffee solubles in the water when extracting coffee. It would also provide another method for calibration of the taste profile of the coffee as per the requirement of the consumer. There is also a need for an apparatus and method using which water direction into the coffee bed and the flow direction of the extracted coffee/espresso can be controlled. There is also a need for an apparatus and method for brewing and extracting coffee which reduces the need to calibrate or change the grind size of the coffee grounds, in order to modify the taste profile of the extracted coffee, leading to a reduction of the resources utilised and the expenses incurred.

### DISCLOSURE OF THE INVENTION

The principal object of the invention is to provide an improved method and apparatus for brewing and extracting coffee.

Another object of the invention is to provide a method and apparatus used to extract coffee solubles in an even and efficient manner, with the extracted coffee, coffee beverage, liquid or espresso having a desirable taste profile.

Another object of the invention is to provide a multi-directional coffee brewing and extraction method and apparatus, used to evenly and efficiently extract coffee solubles into the extracted coffee, coffee beverage, liquid or espresso, giving the extracted coffee a desirable taste profile.

Another object of the invention is to provide a method and apparatus for brewing and extracting coffee in coffee machines which can be used io calibrate the taste profile of the extracted coffee, coffee beverage, liquid, or espresso. Another object of the invention is to provide such a method and apparatus for brewing and extracting coffee which can be easily implemented in coffee brewers, coffee machines and espresso machines.

Another object of the invention is to provide a method and apparatus that facilitates the convenient modification and calibration of the taste profile of extracted coffee, reducing the need to change the grind size of the coffee grounds.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

The following information presents a simplified summary of the disclosure in order to provide a basic understanding for the reader. This summary does not limit the scope of the invention in any way. Its sole purpose is to summarise some of the concepts disclosed herein as a prelude to the more detailed description that is presented later.

In order to overcome the problem of uneven and inefficient extraction of coffee solubles into the extracted coffee/espresso, especially in coffee machines, the present invention discloses the use of an apparatus to brew and extract coffee where water and/or steam is passed through the coffee bed in multiple directions. The water may be used for the purposes of pre-infusion as well. The extracted coffee, which is normally espresso but could also include other coffee liquids and beverages, is extracted using different methods of extraction, including the use of valves and pipes or tubes. The embodiments of the present invention also lead to a reduction in the need to change the grind size of the coffee grounds to modify or calibrate the taste profile of the extracted coffee. Reference to pipes includes other means of transporting liquids such as tubes and conduits. The opening and closing of valves in a coffee machine facilitates controlling the flow of liquids inside the machine. These valves could either be controlled manually or automatically using a computer, processing unit, microcontroller or microprocessor.

The present invention can be implemented as part of a coffee machine, coffee brewer, coffee extractor, espresso machine, all of which will be referred to as coffee machine for the purposes of this invention. Such machines are commonly used to extract coffee or espressos by brewing coffee grounds by passing water or steam through them, generally under pressure. The level of automation in coffee machines is increasing with improving technology, which means that most steps involved in the preparation of the coffee beverage are being implemented electronically and automatically. Commonly consumed beverages such as cappuccinos and lattes, whether hand-made or machine-made, are prepared from the extracted espresso, by mixing the espresso with other components such as water, milk, and sugar.

In one embodiment of the present invention, the water is passed through the coffee bed (in the coffee brewer/coffee machine) in two directions i.e, from top to bottom and from bottom to top (including a pre-infusion option). The flow of water through the coffee bed from top to bottom and from bottom to top is controlled automatically (may be controlled by using a computer, processing unit, microcontroller or microprocessor) by valves, which may account for and measure parameters such as the gravitational pull, water pressure, water temperature, water flow rate and other required parameters. These parameters may depend on the desired extraction and taste profile of the extracted coffee/espresso such as the acidity, juiciness, sweetness, bitterness, body, and aftertaste. Sensors may be placed in the brewing chamber in order to provide information to the computer, processing unit, microcontroller or microprocessor which can regulate the flow of water/steam into the coffee bed using the valves, depending on factors such as the current wetness and solubility of the coffee grounds. Grind size is a feature of coffee grounds that affects the solubility and taste profile of the coffee. Changing the grind size in a coffee machine is an arduous task that requires a skilled person to go on-site and calibrate the grind size for a desirable taste profile. The apparatus and method provided in the embodiments of the present invention reduces the need to change the grind size in order to modify or calibrate the taste profile of the coffee, leading to significant savings in time and resources.

In another embodiment of the present invention, the water is passed through the coffee bed (in the coffee brewer/coffee machine) in two directions i.e. from left to right and from right to left (including a pre-infusion option). The flow of water through the coffee bed in both directions is controlled automatically (may be controlled by using a computer, processing unit, microcontroller or microprocessor) by valves, which account for and measure parameters such as the gravitational pull, water pressure, water flow rate and other required parameters. These parameters may depend on the desired extraction and taste profile of the extracted coffee/espresso such as the acidity, juiciness, sweetness, bitterness, body and after taste. Sensors may be placed in the brewing chamber in order to provide information to the computer, processing unit, microcontroller or microprocessor which can regulate the flow of water/steam into the coffee bed using the valves, depending on factors such as the current wetness and solubility of the coffee grounds. Grind size is a feature of coffee grounds that affects the solubility and taste profile of the coffee. Changing the grind size in a coffee machine is an arduous task that requires a skilled person to go on-site and calibrate the grind size for a desirable taste profile. The apparatus and method provided in the embodiments of the present invention reduces the need to change the grind size in order to modify or calibrate the taste profile of the coffee, leading to significant savings in time and resources.

The coffee/espresso may be extracted, in either of the above described embodiments using a single extraction pipe or multiple extraction pipes, using a different set of electronically controlled valves. The valves may be controlled using a computer, processing unit, microcontroller or microprocessor. Such a computer, processing unit, microcontroller or microprocessor may receive inputs from sensors as signals and adjust the valve settings in order to regulate the flow of the extracted coffee/espresso based on the received signals. The valves may also be operated using pre-set parameters.

By passing water/steam through the coffee bed in multiple directions, the coffee solubles will be extracted in the extracted coffee/espresso more efficiently and evenly. Coffee solubles refer to substances in coffee beans or coffee grounds that can be dissolved by water. These solubles can include acids (such as malic, citric, acetic, lactic or chlorogenic acids), lipids, fats, melanoidins, caffeine, carbohydrates and coffee bean fibres. Given the saturation limit of water (when dissolving coffee solubles), the two or more directions in which the water passes through the coffee bed will facilitate improved dissolution of the coffee solubles into the water, as per the desired taste profile.

This method and apparatus will also provide another method of calibrating the taste profile of the extracted coffee. The calibration can be controlled by the computer, processing unit, microcontroller or microprocessor by controlling the volume, pressure and temperature of the water/steam that is passed through the coffee bed in any of the multiple directions.

The above described embodiments are exemplary and outline rather broadly, the features and technical advantages of the present invention, in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilised as a basis for modifying or designing other structures or processes for carrying out the same purposes of the present invention.

Other aspects of the embodiments of the invention described herein will be better appreciated and understood when considered in conjunction with the following detailed description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof.

### BRIEF DESCRIPTION OF DRAWINGS

FIG. 1 shows a flow chart outlining the general steps involved in the preparation of an espresso and other beverages, in a coffee machine which is substantially automated.

FIG. 2 shows the coffee bed, divided into three layers (for representation), with water passing through the coffee bed in one direction i.e. from top to bottom.

FIG. 3 shows the coffee bed, divided into three layers (for representation), with water passing through the coffee bed in two substantially opposite directions i.e. from top to bottom and from the bottom to top.

FIG. 4 shows an apparatus for the dual directional brewing and extraction of coffee using two pipes for supplying water to the coffee bed and two pipes for extraction of the extracted coffee/espresso.

FIG. 5 shows an apparatus for the dual directional brewing and extraction of coffee using two pipes for supplying water to the coffee bed and one pipe for extraction of the extracted coffee/espresso.

FIG. 6. shows an apparatus for the dual directional brewing and extraction of coffee using two pipes for supplying water to the coffee bed and one pipe for extraction of the extracted coffee/espresso, where the water supply pipe is connected to the extraction pipe before connecting to the brewing chamber.

### DESCRIPTION OF THE INVENTION

The implementation of the preferred embodiments is discussed in detail below. It should be understood, however, that the present invention provides a broad scope of inventive concepts that can be embodied in a variety of specific implementations. The specific embodiments discussed herein are merely illustrative of specific ways to implement the invention and do not, in any manner, limit the scope of the invention.

In the following description, numerous specific details are set forth in order to provide a thorough understanding of embodiments of the present invention. It will be apparent to one skilled in the art that embodiments of the present invention may be practised without some of these specific details.

If the specification discloses a component or feature that “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “i n” includes “in” and “on” unless the context clearly dictates otherwise.

Throughout this specification, the use of the word “comprise” and “include”, and variations such as “comprises”, “comprising”, “includes”, and “including” may imply the inclusion of other elements, not specifically recited as well.

Exemplary embodiments will now be described more fully hereafter with reference to the accompanying drawings, in which exemplary embodiments are shown. This invention may, however, be embodied in many different forms ami should not be construed as limited to the embodiments set forth herein. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Numerous modifications, changes, variations, substitutions, and equivalents of the embodiments described herein will be apparent to those skilled in the art, without departing from the spirit and scope of the invention.

In this specification, reference to water includes reference to water in liquid form as well as in gaseous form (such as steam). Furthermore, the water may be of any temperature even though in certain embodiments of the present invention, the water used to brew the coffee is heated.

The present invention shall not be restricted to a specific type of coffee machine, unless specifically mentioned otherwise or the context specifically requires otherwise.

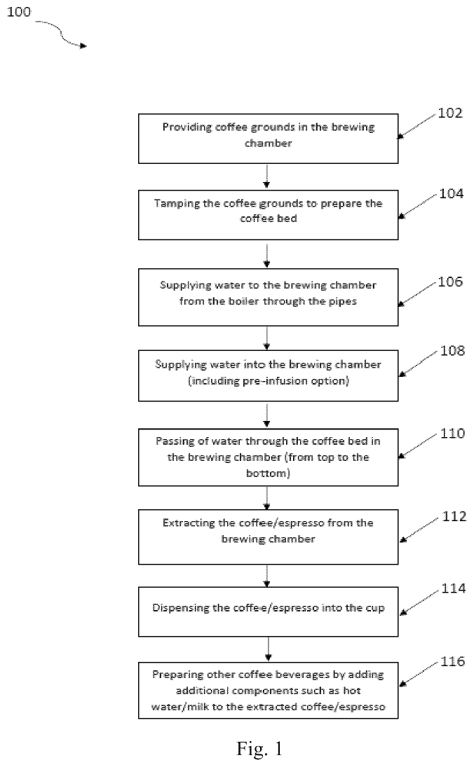

There are several steps undertaken by a coffee machine in order to prepare a coffee beverage, once a consumer has selected their choice of coffee beverage. FIG. 1 outlines the steps involved in a method 100 to prepare an espresso and other coffee beverages that are made with espresso, by a coffee machine.

Coffee grounds are prepared by grinding the coffee beans, which are already roasted in most cases. The grind size of the coffee grounds can affect their solubility and other physical characteristics, which can be used to modify the taste profile of the extracted coffee, ((hanging the grind size, however, is an arduous task and the need to do the same can be mitigated by using the method and apparatus as provided in embodiments of the present invention. These coffee grounds are provided in the brewing chamber in step 102. The brewing chamber is a container in which the coffee grounds are placed.

The coffee grounds are then tamped to compress the coffee grounds and even the horizontal spread of the coffee grounds, to prepare the coffee bed in step 104.

Method 100 includes supplying water to the brewing chamber from the boiler through the pipes in the machine in step 106. The temperature of the water is determined by the machine based on the desired taste profile of the coffee beverage. In alternative embodiments of the present invention, cold water may also be used.

Method 100 further includes supplying water into the brewing chamber, generally under pressure in step 108. The supplied water may contain steam. The option of pre-infusion or pre-wetting is also available.

The water is inserted into and passed through the coffee bed at a certain rate, generally in one direction i.e. from top to bottom (in existing coffee machines), in order to extract the coffee solubles from the coffee grounds into the water in step 110. Coffee solubles refer to substances in coffee beans or coffee grounds that can be dissolved by water. These solubles can include acids (such as malic, citric, acetic, lactic or chlorogenic acids), lipids, fats, melanoidins, caffeine, carbohydrates and coffee bean fibres. The coffee is now brewed.

Method 100 also includes extracting the brewed coffee, which is generally espresso, from the brewing chamber using pipes towards the dispenser in step 112.

Method 100 further includes dispensing the brewed coffee/espresso into a cup by the machine in step 114.

Although the embodiments of the present invention describe the use of a boiler and heated water (which may contain steam), use of unheated/cold water to brew or extract coffee also falls within the scope of the present invention.

In order to prepare other coffee beverages such as cappuccinos and lattes, which use espresso as an intermediate product, additional steps may be involved in the preparation of the beverage after the espresso is prepared. Addition of other components, such as hot water and milk, in step 116 may take place before or after the dispensation of the espresso into the cup. Preparation of such beverages also falls within the scope of the present invention as well.

It should be noted that the steps required to be undertaken with a fully automated and semi-automated coffee machine are substantially similar. In the case of a semi-automated coffee machine, a person (such as a barista or the consumer) is responsible for some of the steps undertaken when preparing the coffee beverage. Whereas, in the case of a fully automated machine, the machine undertakes all of the steps required to prepare the coffee beverage.

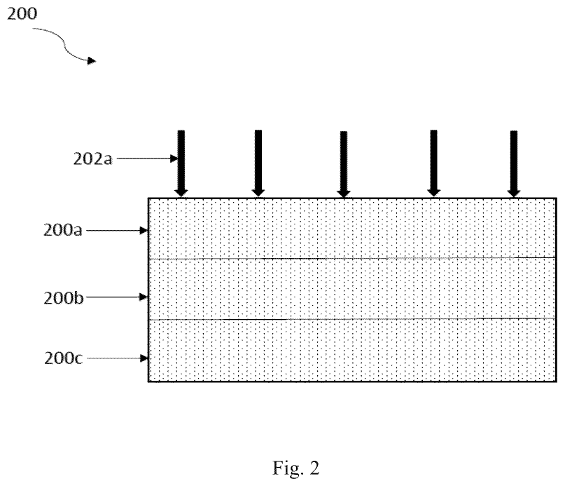

FIG. 2 shows the coffee bed 200 which is generally present in the brewing chamber. In FIG. 2, the coffee bed 200 is brewed using water and/or steam being passed in one direction only i.e. from top to bottom 202a. FIG. 2 is representative of the technology currently used in coffee machines to brew the coffee. The three representative layers of the coffee bed 200 are layer 200a, layer 200b and layer 200c.

200a is the layer of the coffee bed 200 through which the water first enters the coffee bed 200. 200c is the last layer of the coffee bed 200 through which the water passes.

When the water passes through the coffee bed 200, coffee solubles present in layer 200a are extracted the most and the coffee solubles present in layer 200c are the least extracted. The reason behind this uneven extraction of the coffee solubles into die water is the saturation limit of water. Furthermore, there is a significant amount of coffee grounds in layer 200c that still contain extractable coffee solubles which are wasted.

This uneven and inefficient extraction of coffee solubles leads to wastage of coffee grounds in addition to the undesirable and unreliable taste profile of the extracted coffee/espresso.

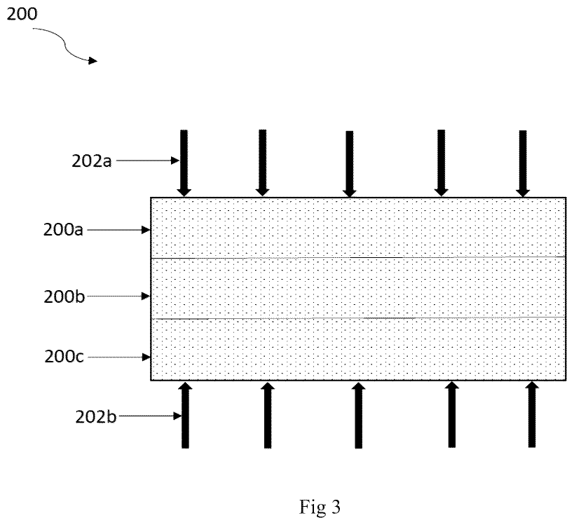

FIG. 3 shows the coffee bed 200 as part of an exemplary and non-limiting embodiment of the present invention, wherein the water and/or steam enters the coffee bed 200 from two directions i.e. from the top to the bottom 202a and from the bottom to the top 202b.

FIG. 3 shows the coffee bed 200 in an exemplary and non-limiting embodiment of the present invention that improves upon the disadvantages of the existing technology for brewing die coffee bed 200 in FIG. 2. The coffee bed 200 is divided into three representative layers i.e. layer 200a, layer 200b and layer 200c.

The waler is inserted into the coffee bed 200 from multiple directions i.e. from top to bottom 202a and from bottom to top 202b, Whiter flowing in the top to bottom direction 202a makes contact with layer 200a of the coffee bed 200. Water flowing in the bottom to top direction 202b makes contact with layer 200a of the coffee bed 200. The water flows in both directions 202a and 202b, through the coffee bed 200. This leads to the coffee solubles being more evenly and efficiently extracted, causing reduced wastage. This method of brewing and extracting coffee solubles from the coffee bed 200 also improves the reliability of the calibrated taste profile of the beverage.

The flow of water in the two directions 202a and 202b can be controlled by a computer, processing unit, microcontroller or microprocessor, in order to calibrate the taste profile of the extracted coffee or for any other purpose. The flow of water in the two directions 202a and 202b can be pre-set. The flow of water, however, can vary depending on real time measurements and parameters such as temperature and pressure.

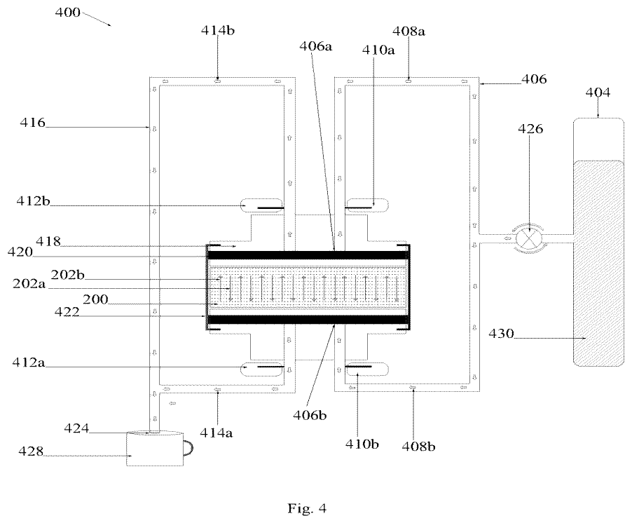

FIG. 4 shows the coffee brewing and extraction apparatus 400 in an exemplary and non-limiting embodiment of the present invention implemented as part of a coffee machine.

The boiler 404 is used to heat up the water 430. The water passes through the flow-meter 426 and into the brewing chamber 422 through the water pipe 406. The water flows 408a and 408b towards the valves 410a and 410b through the pipe 406. The valves 410a and 410b may be connected to a computer, processing unit, microcontroller or microprocessor that controls the valves 410a and 410b to regulate the flow of water 408a and 408b into the brewing chamber 422 and the coffee bed 200 through entry points 406a and 406b respectively. The coffee bed 200 is the same as the one shown in FIG. 2 and FIG. 3. The brewing chamber 422 is a container in which the coffee bed 200 is placed.

The water enters the brewing chamber 422 through the pipe 406 in the top to bottom direction 202a through entry point 406a and the bottom to top direction 202b through entry point 406b, as permitted by the valves 410a and 410b. The water flowing from the top to bottom direction 202a may flow through the tamper 418. The tamper 418 has a gasket 420 as well.

The coffee is brewed in the brewing chamber 422 for the desired time period using the water flow in both directions 202a and 202b, which can be regulated as required. The water containing the extracted coffee solubles is extracted using the extraction pipe 416. In the embodiment shown in FIG. 4, there are two points at which the extraction pipe 416 connects to the brewing chamber 422. A combination of pressure systems and pumps may be used on the extraction side of the said apparatus to extract the coffee/espresso from the brewing chamber 422.

Valves 412a and 412b are used to control the flow of the extracted coffee/espresso 414a and 414b through the extraction pipe 416. The extracted coffee flows from the brewing chamber 422 towards the dispensing point 424.

The extracted coffee/espresso is dispensed into the cup 428. In case the consumer did not request an espresso, other components such as hot water, milk and sugar are dispensed by the coffee machine into the cup 428 to prepare the final coffee beverage.

The apparatus, as shown in the embodiment of the present invention in FIG. 4. overcomes several disadvantages present in the current coffee brewing and extraction technology. The coffee solubles in the coffee bed 200 are more evenly and efficiently extracted into the espresso as the water passes through the coffee bed 200 in multiple directions 202a and 202b. In this embodiment, the ability to control the flow of water in both directions 202a and 202b using a computer, processing unit, microcontroller or microprocessor, independently and based on parameters that are monitored in real time, improves the taste profile of the extracted coffee while reducing the amount of coffee left unextracted and wasted. The apparatus, as shown in the embodiment of the present invention in FIG. 4, reduces the need to change the grind size of the coffee grounds in order to modify the taste profile of the extracted coffee.

The even extraction of the coffee bed is clearly evidenced by the data collected when conducting the following test which was performed using the Frankie 300 automatic coffee machine with the Catuai variety of the Arabica-Brazil Santa Lucia coffee beans prepared by using the natural drying method patio. 31 g (±1 g) of coffee beans were ground (into coffee grounds) and brewed at 90° C. and 8 bar pressure in the coffee brewer for 19s (±2s) to extract 120 mL of brewed espresso coffee from the coffee machine. The brewed coffee/espresso prepared using the method and apparatus as disclosed in the embodiments of the present invention is compared with the conventional method of brewing and extracting coffee.

The key findings from the above test have been provided below:

a. Two coffee beds for each method and apparatus, after the espresso had been brewed and extracted, were horizontally cut in half (so as to present a top layer and a bottom layer) and analysed for the presence of Total Soluble Solids (TSS) in each layer. Method-1 is the conventional method for coffee extraction whereas Method-2 is conducted as per the embodiments of the present invention. The TSS in each layer were measured as ‘x’ mg of caffeme m 1 kg of espresso solution:—

| | Method-1 | | Method-2 | |
|---|---|---|---|---|
| | (Conventional method) | | (Present Invention Method) | |
| S No. | Layer | TSS (mg/kg) | Layer | TSS (mg/kg) |
| 1. | Top 1 | 2600 | Top 1 | 2300 |
| 2. | Top 2 | 2600 | Top 2 | 2800 |
| Top Average TSS | | 2600 | | 2550 |
| 1. | Bottom 1 | 2200 | Bottom 1 | 2400 |
| 2. | Bottom 2 | 2100 | Bottom 2 | 2400 |

| | | |
|---|---|---|
| Bottom Average | 2150 | 2400 |
| TSS | | |

As can be clearly seen from a comparison of the Top Average TSS and Bottom Average TSS for Method-2, the extraction of coffee is even and consistent when compared to the Top Average TSS and Bottom Average TSS obtained using Method-1. The difference between the Top Average TSS and Bottom Average TSS using Method-1 is stark-450 mg/kg to be precise. In comparison, this difference is only 150 mg/kg when Method-2 is used. This clearly shows that in Method-1 the top-layer is undesirably over-extracted (in an uneven manner) when compared with the bottom-layer.

b. The Total Soluble Solids (TSS), in both the coffee beds, were then analysed for non-caffeine content and the key findings are provided as follows:

| | Method-1 | | Method-2 | |
|---|---|---|---|---|
| | (Conventional method) | | (Present Invention Method) | |
| S No. | Layer | TSS (mg/kg) | Layer | TSS (mg/kg) |
| 1. | Top 1 | 2343.58 | Top 1 | 1958.51 |
| 2. | Top 2 | 2267.04 | Top 2 | 2448.2 |
| Top Average TSS | | 2305.31 | | 2203.355 |
| 1. | Bottom 1 | 1981.5 | Bottom 1 | 2154.67 |
| 2, | Bottom 2 | 1874.65 | Bottom 2 | 2140.75 |

| | | |
|---|---|---|
| Bottom Average | 1928.075 | 2147.71 |
| TSS | | |

As can be clearly seen from a comparison of the Top Average TSS and Bottom Average TSS obtained using Method-2, there is an even extraction from both layers of the coffee bed. Whereas, the Top Average TSS and the Bottom Average TSS obtained using Method-1 show a significant difference. In fact, the difference between the Top Average TSS and the Bottom Average TSS for Method-1 is stark-377.235 mgZkg to be precise. In comparison, this difference is only 55.65 mg/kg when Method-2 is used. This clearly shows that in Method-1 the top-layer is undesirably over-extracted (in an uneven manner) when compared with the bottom-layer.

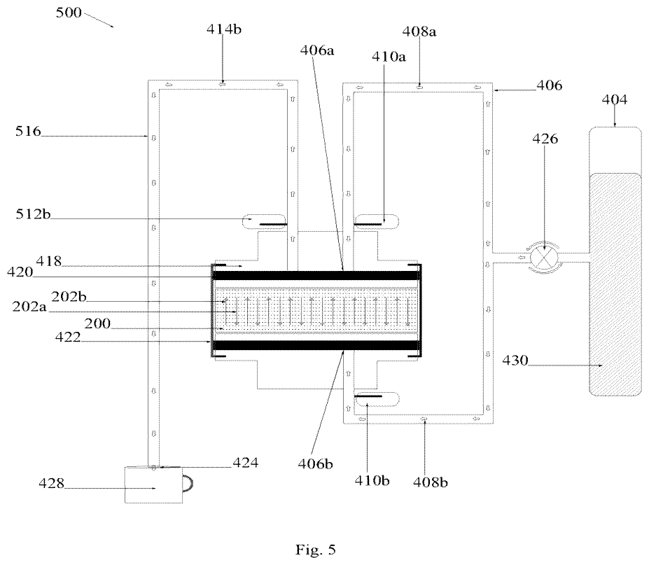

FIG. 5 shows the coffee brewing and extraction apparatus 500 in another exemplary and non-limiting embodiment of the present invention. The water supply and brewing chamber system in FIG. 5 is the same as that of FIG. 4. The apparatus 500 has a single extraction pipe 516 to extract the extracted coffee/espresso from the brewing chamber 422. Due to the presence of a single extraction pipe 516, a single valve 512b is used to control the flow of the extracted coffee/espresso 414b into the cup 428.

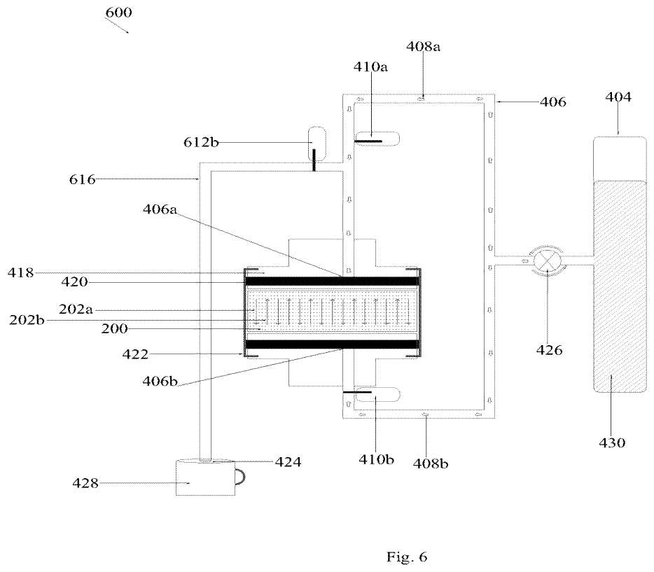

FIG. 6 shows the coffee brewing and extraction apparatus 600 in another exemplary and non-limiting embodiment of the present invention. The water supply and brewing chamber system in FIG. 6 is almost the same as that of FIG. 5. The extraction pipe 616 is connected to the pipe 406 delivering water to the brewing chamber 422. A common junction point is shared with the brewing chamber 422 by the extraction pipe 616 and one end of the water delivery pipe 406. Valve 612b is used to control the flow of the extracted coffee/espresso from the brewing chamber 422 to the cup 428 through the extraction pipe 616.

The above described embodiments of the present are exemplary and non-limiting. They describe specific implementations of the present invention which are not to be construed as limiting the scope of the invention. The present invention can be implemented in different manners and with modifications, which would be obvious to a person skilled in the art, without departing from the spirit and scope of the invention.

I claim:

1. A method for extracting coffee solubles from coffee grounds in a coffee machine, comprising the steps of:
placing the coffee grounds in a container in the coffee machine;
inserting water into the coffee grounds at two or more locations; and
extracting the water which contains the coffee solubles from the coffee grounds.

2. The method as claimed in claim 1, wherein the water is inserted into the coffee grounds using a first set of one or more pipes.

3. The method as claimed in claim 2, wherein a first set of one or more valves is used to control the flow of water through the first set of one or more pipes.

4. The method as claimed in claim 3, wherein the first set of one or more valves is controlled using a computer, processing unit, microcontroller or microprocessor.

5. The method as claimed in claim 1, wherein at least two of the said locations are on opposite sides of the coffee grounds.

6. The method as claimed in claim 1, wherein the water is inserted at the top of the coffee grounds and at the bottom of the coffee grounds.

7. The method as claimed in claim 1, wherein the water which contains the coffee solubles is extracted using a second set of one or more pipes.

8. The method as claimed in claim 7, wherein a second set of one or more valves is used to control the flow of water through the second set of one or more pipes.

9. The method as claimed in claim 8, wherein the second set of one or more valves is controlled using a computer, processing unit, microcontroller or microprocessor.

10. The method as claimed in claim 1, wherein the water which contains the coffee solubles is espresso.

11. An apparatus comprising:
a container to place coffee grounds in;
a first set of one or more pipes to deliver water to the coffee grounds at two or more locations; and
a second set of one or more pipes to extract the water which contains coffee solubles from the coffee grounds.

12. The apparatus as claimed in claim 11, wherein the flow of water through the first set of one or more pipes is controlled using a first set of one or more valves.

13. The apparatus as claimed in claim 12, wherein the first set of one or more valves is controlled using a computer, processing unit, microcontroller or microprocessor.

14. The apparatus as claimed in claim 11, wherein the water is delivered to the coffee grounds on opposite sides of the coffee grounds.

15. The apparatus as claimed in claim 11, wherein the water is inserted at the top of the coffee grounds and at the bottom of the coffee grounds.

16. The apparatus as claimed in claim 11, wherein a second set of one or more valves is used to control the flow of the water which contains the coffee solubles through the second set of one or more pipes.

17. The apparatus as claimed in claim 16, wherein the second set of one or more valves is controlled using a computer, processing unit, microcontroller or microprocessor.

18. The apparatus as claimed in claim 11, wherein the water which contains the coffee solubles is espresso.

19. A coffee machine comprising:
a boiler;
a brewing chamber in which coffee grounds are placed;
a first set of one or more pipes that deliver water from the boiler to the brewing chamber;
a second set of one or more pipes;
a first set of one or more valves that control the flow of water through the first set of one or more pipes; and
a second set of one or more valves that control the flow of water which contains coffee solubles through the second set of one or more pipes;
wherein the water flowing through the first set of one or more pipes is delivered to the coffee grounds at two or more locations.

20. The coffee machine as claimed in claim 19, wherein at least two of the two or more locations are on opposite sides of the coffee grounds.
